(19) United States
(12) Patent Application Publication
(10) Pub. No.: US 2020/0252336 A1
(43) Pub. Date: Aug. 6, 2020

(54) SWITCHING FABRIC CONFIGURATION AND MANAGEMENT SYSTEM

(71) Applicant: Dell Products L.P., Round Rock, TX (US)

(72) Inventors: Joseph LaSalle White, San Jose, CA (US); Balaji Rajagopalan, Sunnyvale, CA (US); Pawan Kumar Singal, Milpitas, CA (US); Charles Chul Hyun Park, San Jose, CA (US); Saleem Muhammad, Santa Clara, CA (US)

(21) Appl. No.: 16/263,791

(22) Filed: Jan. 31, 2019

(51) Int. Cl. H04L 12/713; H04L 12/947; H04L 12/933; H04L 12/715; H04L 12/46

(52) U.S. Cl. CPC H04L 45/586; H04L 49/25; H04L 12/4641; H04L 45/64; H04L 49/102

(57) ABSTRACT

A switching fabric configuration and management system includes switch devices. Each of the switch devices identifies a domain in a switching fabric database in that switch device, and determines others of the switch devices that share the domain. Each of the switch devices may then communicate with the others of the switch devices that share the domain to designate a master switch device and one or more slave switch devices from the switch devices that share the domain. The designation of the master switch device and the one or more slave switch devices configures the master switch device and the one or more slave switch devices as a switching fabric. Each slave switch devices then reports their slave switch device status to the master switch device, and the master switch device performs at least one control operation on the at least one slave switch device.

### BACKGROUND

The present disclosure relates generally to information handling systems, and more particularly to configuring and managing a switching fabric provided by a plurality of information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, switch devices, are often configured to provide switching fabrics. However, the configuration and management of conventional switching fabrics is associated with complexity, ongoing operational overhead, and relatively long times required for new system deployment. Software Defined Networking (SDN) techniques have been developed to alleviate some of the management and control issues associated with conventional switching fabrics, but are still associated with complex configuration operations and relatively long configuration times. In addition, such techniques require a device external to the switching fabric (e.g., a server device upon which an SDN controller operates in order to manage and control SDN switch devices in the switching fabric) in order to provide for management and control of the switching fabric, which increases the cost of managing and controlling the switching fabric.

Accordingly, it would be desirable to provide an improved switching fabric configuration and management system.

### SUMMARY

According to one embodiment, an Information Handling System (IHS) includes a processing system; and a memory system that is coupled to the processing system and that includes instructions that, when executed by the processing system, cause the processing system to provide a switching fabric engine that is configured to: identify, in a switching fabric database, a domain; determine at least one switch device that shares the domain; communicate with the at least one switch device that shares the domain to designate the IHS as a master switch device and the at least one switch device that shares the domain as at least one slave switch device, wherein the designation of the master switch device and the at least one slave switch device configures the master switch device and the at least one slave switch device as a switching fabric; receive, from each of the at least one slave switch device, a report of their slave switch device status; and perform at least one control operation on the at least one slave switch device

### BRIEF DESCRIPTION OF THE DRAWINGS

FIG. 1 is a schematic view illustrating an embodiment of an Information Handling System (IHS).

FIG. 2 is a schematic view illustrating an embodiment of a switching fabric configuration and management system.

FIG. 3 is a schematic view illustrating an embodiment of a switch device that may be provided in the switching fabric configuration and management system of FIG. 2.

FIG. 4 is a flow chart illustrating an embodiment of a method for configuring and managing a switching fabric.

FIG. 5 is a schematic view illustrating an embodiment of the switching fabric configuration and management system of FIG. 2 during the method of FIG. 4.

FIG. 6 is a schematic view illustrating an embodiment of the switching fabric configuration and management system of FIG. 2 during the method of FIG. 4.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

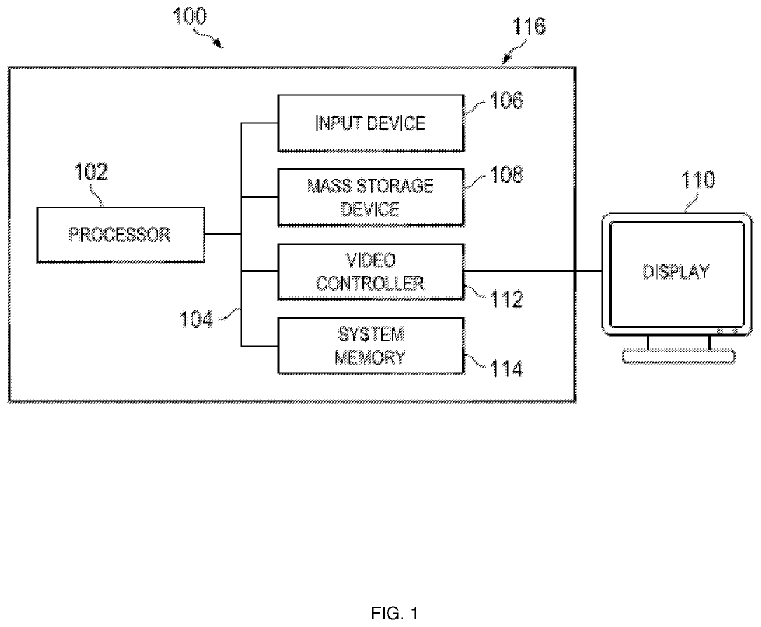

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

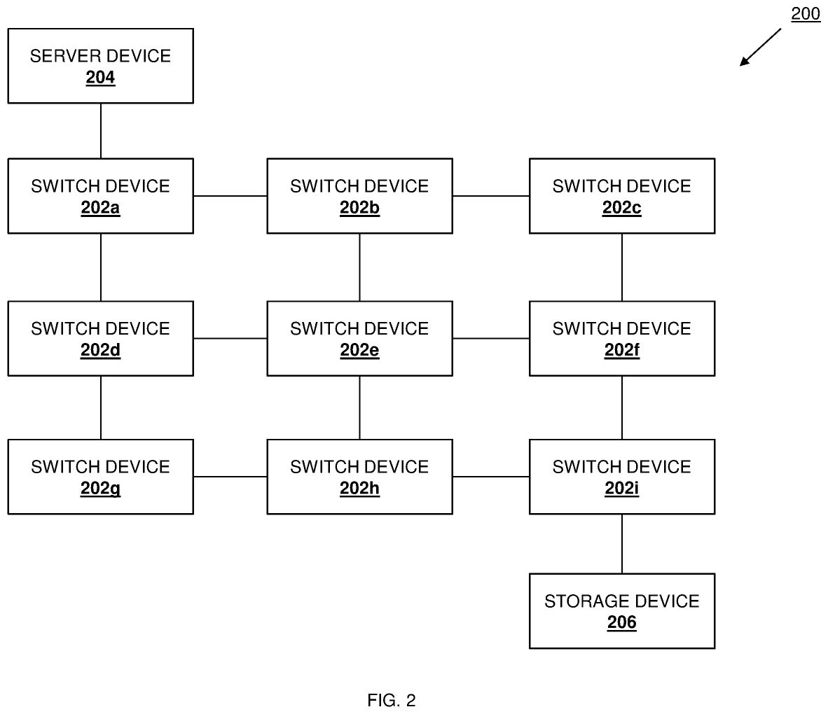

Referring now to FIG. 2, an embodiment of a switching fabric configuration and management system 200 is illustrated. In the illustrated embodiment, the switching fabric configuration and management system 200 includes a plurality of networking devices such as, for example, the switch devices 202a, 202b, 202c, 202d, 202e, 202f, 202g, 202h, and 202i, illustrated in FIG. 2. In an embodiment, any or all of the switch devices 202a-i may be provided by the IHS 100 discussed above with reference to FIG. 1, and/or may include some or all of the components of the IHS 100. However, while illustrated and discussed as switch devices, one of skill in the art in possession of the present disclosure will recognize that a variety of networking devices may provide in the switching fabric configuration and management system 200 of the present disclosure, and any devices that may be configured to operate in a fabric similarly as discussed for the switching fabric described below may benefit from the teachings of the present disclosure as well. As would be understood by one of skill in the art in possession of the present disclosure, any of the switch devices 202a-i may be coupled to endhost device(s). For example, in the illustrated embodiment, the switch device 202a is coupled to an endhost device provided by a server device 204, and the switch device 202i is coupled to an endhost device provided by a storage device 206. Each of the server device 204 and storage device 206 may be provided by the IHS 100 discussed above with reference to FIG. 1, and/or may include some or all of the components of the IHS 100. However, one of skill in the art in possession of the present disclosure will recognize that many more endhost devices may (and typically will) be coupled to any of the switch devices 202a-i (e.g., an a datacenter) while remaining within the scope of the present disclosure, and may be provided by a variety of compute/storage nodes known in the art. Furthermore, management devices and/or other devices may be provided as endhost devices while remaining within the scope of the present disclosure as well. While a specific switching fabric configuration and management system 200 has been illustrated and described, one of skill in the art in possession of the present disclosure will recognize that the switching fabric configuration and management system of the present disclosure may include a variety of components and component configurations while remaining within the scope of the present disclosure as well.

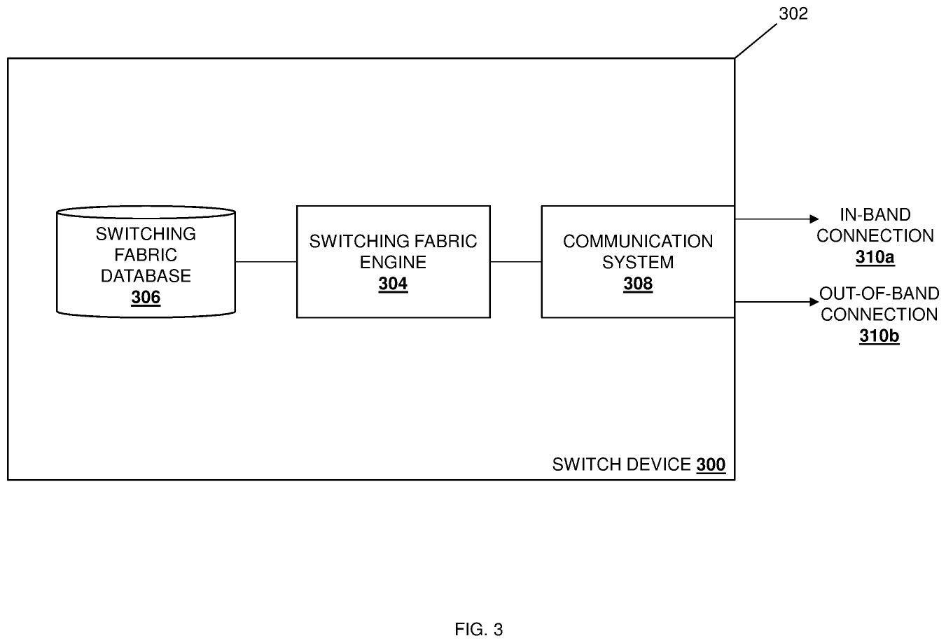

Referring now to FIG. 3, an embodiment of a switch device 300 is illustrated that may provide any or all of the switch devices 202a-i discussed above with reference to FIG. 2. As such, the switch device 300 may be provided by the IHS 100 discussed above with reference to FIG. 1 and/or may include some or all of the components of the IHS 100. Furthermore, while illustrated and discussed as a switch device, one of skill in the art in possession of the present disclosure will recognize that the functionality of the switch device 300 discussed below may be provided by other networking devices and/other devices that are configured to operate in a fabric similarly as discussed for the switching fabric described below. In the illustrated embodiment, the switch device 300 includes a chassis 302 that houses the components of the switch device 300, only some of which are illustrated below.

For example, the chassis 302 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a switching fabric engine 304 that is configured to perform the functionality of the switching fabric engines and/or switch devices discussed below. In a specific example, the switching fabric engine 304 may be provided, at least in part, by a Central Processing Unit (CPU) in the switch device 300 that is separate from a Network Processing Unit (NPU) in the switch device 300 that performs conventional switch device functions (e.g., data path determination and data path forwarding), and that may be included in instructions on the memory system that, when executed by the CPU, cause the CPU to provide the DELL® Operating System 10 (OS10) available from DELL® Inc., of Round Rock, Tex., United States, configures the NPU to perform the switch device functions, and/or performs a variety of other CPU functionality known in the art. Furthermore, at least some of the functionality of the switching fabric engine 304 may be provided by agent(s) included on the switch device 300.

The chassis 302 may also house a storage system (not illustrated, but which may include the storage 108 discussed above with reference to FIG. 1) that is coupled to the switching fabric engine 304 (e.g., via a coupling between the storage system and the processing system) and that includes a switching fabric database 306 that is configured to store any of the information utilized by the switching fabric engine 304 discussed below. The chassis 302 may also house a communication system 308 that is coupled to the switching fabric engine 304 (e.g., via a coupling between the communication system 308 and the processing system) and that may be provided by a Network Interface Controller (NIC), wireless communication systems (e.g., BLUETOOTH®, Near Field Communication (NFC) components, WiFi components, etc.), and/or any other communication components that would be apparent to one of skill in the art in possession of the present disclosure. As can be seen, the communication system 308 may provide either or both of an in-band connection 310a and an out-of-band connection 310b to, for example, the other switch devices, endhosts, management devices, and/or any other device that would be apparent to one of skill in the art in possession of the present disclosure. While a specific switch device 300 has been illustrated and described, one of skill in the art in possession of the present disclosure will recognize that switch devices (or other devices operating according to the teachings of the present disclosure in a manner similar to that described below for the switch device 300) may include a variety of components and/or component configurations for providing conventional switch device functionality, as well as the functionality discussed below, while remaining within the scope of the present disclosure as well.

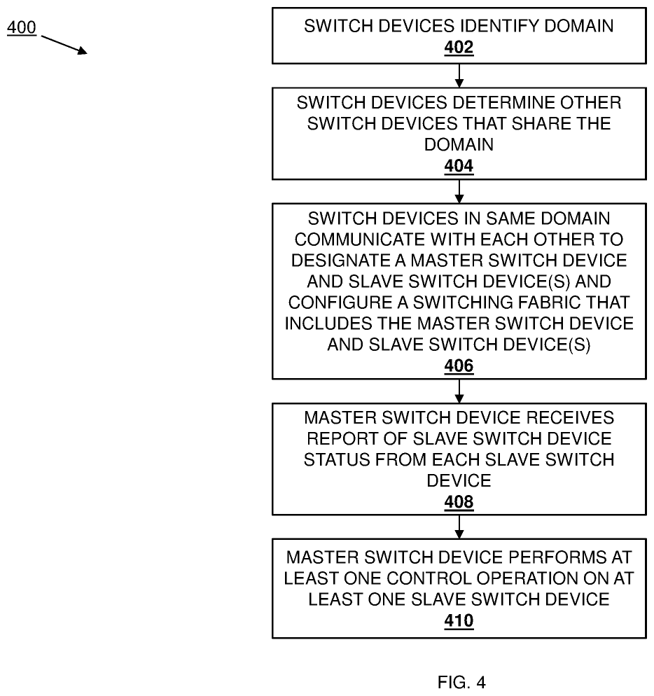

Referring now to FIG. 4, an embodiment of a method for configuring and managing a switching fabric is illustrated. As discussed below, the systems and methods of the present disclosure provide for the configuration of switching fabrics in a manner that reduces the complexity, ongoing operational overhead, and relatively long times required for new system deployment, as well as eliminates the need for to provide a device external to the switching fabric that performs the management and control functionality for the switching fabric, thus reducing the cost of managing and controlling the switching fabric. For example, the switching fabrics provided via the teachings of the present disclosure may only require a plurality of switch devices that operate to configure themselves into a switching fabric via communications that result in those devices discovering each other and forming a switch device cluster, and then electing one of those switch devices as a master switch device for the switch device cluster/switching fabric and the remaining switch devices as slave switch devices in the switch device cluster/switching fabric. Following the configuration of the switching fabric, the master switch device may perform control/management operations on any of the slave switch devices. Furthermore, the master switch device may share its master switch device configuration with each of the slave switch devices, which allows any of those slave switch devices to configure themselves as a master switch device in the event the switch device that is operating as the master switch device becomes unavailable. As such, in some embodiments, switching fabrics may be configured and managed without the need for an external device with a Central Processing Units (CPU), and may instead be configured and managed using the CPU in the switch devices that make up the switching fabric.

The method 400 begins at block 402 where switch devices identify a domain. In an embodiment, at or prior to block 402, each switch device that is to-be utilized to provide the switching fabric according to the teachings of the present disclosure may be provided a common domain identifier that identifies a common domain for those switch devices. For example, with reference to FIG. 2 and the examples provided below, each of the switch devices 202a-i are utilized to provide the switching fabric according to the teachings of the present disclosure, and a common domain identifier may be provided in the switching fabric database 306 included in each of those switch devices 202a-i/300. For example, a network administrator or other user of the switch devices 202a-i may provide the common domain identifier in the switching fabric database 306 of each of the switch devices 202a-i/300 in order to configure those switch devices 202a-i/300 for the switching fabric discussed below. However, while the use of a domain identifier in configuring the switching fabric of the present disclosure is described below, one of skill in the art in possession of the present disclosure will recognize that other switch device personality information (e.g., DELL® OS10 personality information) may be utilized to configure the switching fabric in manner similar to that described for the domain identifier below while remaining within the scope of the present disclosure as well.

As such, in some specific examples, the network administrator or other user may cable a management device to each switch device 300 (e.g., via a management port on the communication system 308), and use an input subsystem on the management device to log into each switch device 300 and provide the domain identifier to the switching fabric engine 304 for storage in the switching fabric database 306. However, in other specific examples, the network administrator or other user may use a management device to access each switch device 300 via a management network that is coupled to the communication system 308, and log into each switch device 300 to provide the domain identifier to the switching fabric engine 304 in each switch device 202a-i/300 for storage in the switching fabric database 306. While a few specific examples have been described, one of skill in the art in possession of the present disclosure will recognize that the common domain identifier may be provided in the switching fabric database 306 of each of the switch devices 202a-i/300 in a variety of manners that will fall within the scope of the present disclosure as well.

At block 402, the switching fabric engine 304 in each switch device 202a-i/300 may operate to access its switching fabric database 306 and identify the domain identifier stored therein. For example, at or prior to block 402, a network administrator or other user may couple together each of the switch devices 202a-i (e.g., via a variety of cabling and coupling techniques that would be apparent to one of skill in the art in possession of the present disclosure) and/or provide each of the switch devices 202a-i as part of a Local Area Network (LAN). Following the coupling together of the switch devices 202a-i, each of those switch devices 202a-i may be powered on, booted, and/or otherwise initialized and, in response, the switching fabric engine 304 in each switch device 202a-i/300 may operate to access its switching fabric database 306 and identify the domain identifier that was provided as discussed above. However, while a specific example has been described, one of skill in the art in possession of the present disclosure will recognize that a switch device may identify a domain identifier (and a corresponding domain in which that switch device belongs) in a variety of manners that will fall within the scope of the present disclosure as well. As such, following block 402, each switch device 202a-i may have identified the domain to which it belong, as per an assignment by a network administrator or other user of a common domain to each switch device that is to provide the switching fabric of the present disclosure.

The method 400 then proceeds to block 404 where the switch devices determine other switch devices that share the domain. In an embodiment, at block 404, the switching fabric engine 304 in each switch device 202a-i/300 may operate to transmit its domain identifier that was identified at block 402 to at least some of the other switch devices 202a-i/300. As discussed above, the switch devices 202a-i/300 may be part of a LAN, and the switching fabric engine 304 in each switch device 202a-i/300 may transmit its domain identifier over a Virtual LAN (VLAN) provided on that LAN. As such, at block 404 the switch devices 202a-i/300 may exchange their domain identifiers, and the switching fabric engine 304 in each switch device 202a-i/300 may operate to determine the switch devices that share its domain when it receives a domain identifier from those switch devices that matches its domain identifier. While the exchange of domain identifiers between switch devices to allow each of those switch devices to determine that they share a domain with the other switch devices has been described, one of skill in the art in possession of the present disclosure will recognize that switch devices may determine that they share a domain using a variety of techniques that will fall within the scope of the present disclosure as well.

The method 400 then proceeds to block 406 where the switch devices in the same domain communicate with each other to designate a master switch device and slave switch devices, and configure a switching fabric that includes the master switch device and the slave switch device. In an embodiment, at block 406, the switching fabric engine 304 in each switch device 202a-i/300 that was determined to share a domain at block 404 may operate to communicate with each other to designate a master switch device and slave switch devices. For example, the switching fabric engine 304 in each switch device 202a-i/300 that was determined to share a domain at block 404 may communicate using the Virtual Router Redundancy Protocol (VRRP) in order to designate the master switch device and slave switch devices at block 406. One of skill in the art in possession of the present disclosure will recognize that the VRRP is a computer networking protocol that is conventionally used to provide for the automatic assignment of available Internet Protocol (IP) router devices to participating host devices in order to increase the availability and reliability of routing paths via automatic default gateway selections on an IP network, and operates to create virtual router devices (e.g., abstractions of multiple router devices) that include a master router device and slave/backup router devices that operate as a group.

As such, one of skill in the art in possession of the present disclosure will recognize how the switching fabric engine 304 in each switch device 202a-i/300 that was determined to share a domain at block 404 may communicate using the VRRP in order to designate a master switch device and slave switch devices. For example, the communications between the switching fabric engine 304 in each switch device 202a-i/300 using the VRRP in order to designate a master switch device and slave switch devices may include the exchange of IP addresses and the election of the switch device having the lowest IP address as the master switch device, which results in the remaining switch devices being designated as slave switch devices. In some embodiments, the designation of the master switch device may include that master switch device being assigned a unique master switch device IP address that, as discussed below, may be utilized by the slave switch devices to communicate with the master switch device.

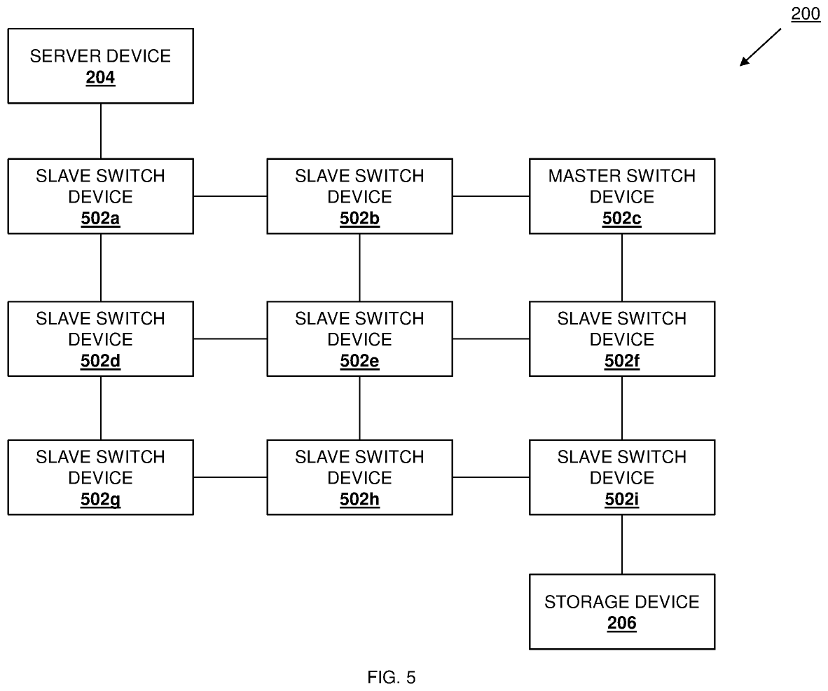

With reference to FIG. 5, an embodiment of the switching fabric configuration and management system 200 discussed above with reference to FIG. 2 is illustrated following the designation of the master switch device and the slave switch devices at block 406. For example, in the embodiment illustrated in FIG. 5 and with reference to FIG. 2, the switch device 202c has been designated as a master switch device 502c, while the switch devices 202a, 202b, and 202d-i have been designated as slave switch devices 502a, 502b, and 502d-i, respectively. In a specific example, at block 406, at least some of the functionality of the switching fabric engine 304 in each switch device 202a-i/300 that allows for the designation of the master switch device and slave switch devices at block 406 may be provided by Keepalived routing software, available from www.keepalived.org, which one of skill in the art in possession of the present disclosure will recognize uses the VRRP. However, while a specific software and protocol has been discussed as being used to designate the master switch device and slave switch devices of the present disclosure, one of skill in the art in possession of the present disclosure will recognize that the master switch device and slave switch devices may be designated in a variety of manners that will fall within the scope of the present disclosure as well.

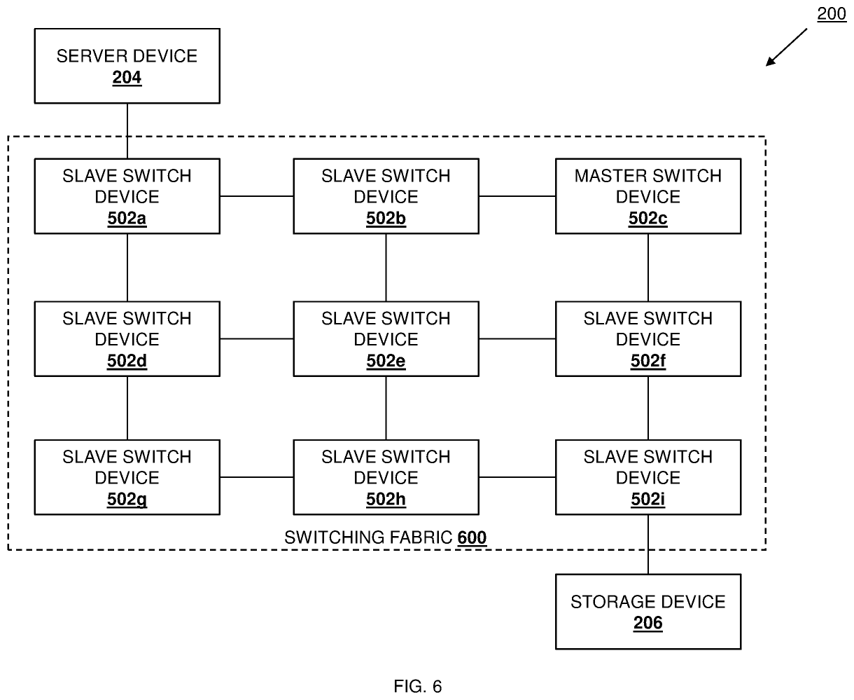

The method 400 then proceeds to block 408 where the master switch device receives a report of a slave switch device status from each slave switch device. In an embodiment, at block 408, the switching fabric engine 304 in each switch device 502a/300, 502b/300, and 502d-i/300 may operate to report its slave switch device status by, for example, generating a slave switch device status report that is directed to the unique master switch device IP address that was assigned to the master switch device 502c as discussed above, and transmitting the slave switch device status report to that unique master switch device IP address. As such, at block 408, the switching fabric engine 304 in the master switch device 502c receives the slave switch device status report from each of the slave switch devices 502a, 502b, and 502d-i. As illustrated in FIG. 6, and as would be understood by one of skill in the art in possession of the present disclosure, the designation of the master switch device 502c and the slave switch devices 502a, 502b, and 502d-i, along with the reporting of the slave switch device status by each of the slave switch devices 502a, 502b, and 502d-i to the master switch device 502c, allows for the configuration of a switch device cluster by the master switch device 502c that provides a switching fabric 600 that includes that master switch device 502c and those slave switch devices 502a, 502b, and 502d-l, and may include a variety of other operations by the master switch device 502c that provides for the configuration of the switching fabric 600 based on any of a variety of switching fabric policies that would be apparent to one of skill in the art in possession of the present disclosure

The method 400 then proceeds to block 410 where the master switch device performs at least one control operation on at least one slave switch device. In an embodiment, at block 410 and following the configuration of the switch device cluster that provides the switching fabric 600, the master switch device 502c and the slave switch devices 502a, 502b, and 502d-i may interact in a variety of manners that provides for the management and control of the switch device cluster that provides the switching fabric 600. For example, one of skill in the art in possession of the present disclosure will recognize the master switch device 502c and the slave switch devices 502a, 502b, and 502d-i provided according to the teachings of the present disclosure may synchronize their states using a distributed object model in order to maintain the switch device cluster that provides the switching fabric 600.

In some embodiments, the communications between the master switch device 502c and the slave switch devices 502a, 502b, and 502d-i may be enabled by each switching fabric engine 304 in each of the master switch device 502c/300 and the slave switch devices 502a/300, 502b/300, and 502d-i/300 performing publish/subscribe (pub/sub) operations, which one of skill in the art in possession of the present disclosure will recognize provides a messaging pattern where senders of messages (called publishers) do not program the messages to be sent directly to specific receivers (called subscribers), but instead categorize published messages into classes without knowledge of which subscribers there may be, while subscribers express interest in one or more classes and only receive messages that are of interest, without knowledge of which publishers there are. In a specific example, the pub/sub operations utilized by the master switch device 502c and the slave switch devices 502a, 502b, and 502d-i may be achieved via a conjunction of Control Plane Services (CPS) available in the DELL® OS10 discussed above, and REmote Dictionary Server (REDIS), which is an open-source in-memory data structure project that implements a distributed, in-memory, key-value database with optional durability.

In some embodiments, the master switch device 502c and the slave switch devices 502a, 502b, and 502d-i may perform database sharing in order to share some or all of the contents of their respective switching fabric databases 306, which may be achieved via a conjunction of CPS, REDIS, and application level client synchronization. In a specific example, the master switch device 502c and the slave switch devices 502a, 502b, and 502d-i may perform the pub/sub operations discussed above, along with the utilization of synchronization applications, in order to provide for the sharing of a master switch device configuration file that describes the configuration of the master switch device 502c. For example, the switching fabric engine 304 in the master switch device 502c/300 may retrieve a master switch device configuration file that is stored in its switching fabric database 306, and publish that master switch device configuration file through the communication system 308 for retrieval by each of the slave switch devices 502a, 502b, and 502d-i. As such, the switching fabric engine 304 in each slave switch devices 502a, 502b, and 502d-i may retrieve that master switch device configuration file via its communication system 308 (e.g., via the subscriptions discussed above), and store that master switch device configuration file in its switching fabric database 306. (e.g., “replicating” the master switch device configuration file on each of the slave switch devices 502a, 502b, and 502d-i).

The master switch device configuration file sharing/replication allows for any of the slave switch devices 502a, 502b, and 502d-i to take over in the event the master switch device 502c become unavailable. For example, the switching fabric engine 304 in each slave switch devices 502a, 502b, and 502d-i may be configured to determine that the master switch device 502c (a primary master switch device in this example) is unavailable (e.g., in response to failing to receive regular communications and/or responses from the master switch device 502c) and, in response, retrieve the master switch device configuration file replicated in its switching fabric database 306 as discussed above, and use that master switch device configuration file to configure itself as a master switch device (e.g., a secondary master switch device in this example) that is capable of performing all of the management/control functionality available from the primary master switch device The determination of which of the slave switch devices 502a, 502b, and 502d-i will take over for an unavailable master switch device may be made based on, for example, the slave switch device with the lowest IP address, keepalived/VRRP master election schemes, and/or a variety of other criteria that would be apparent to one of skill in the art in possession of the present disclosure

In some embodiments, the switching fabric engine 304 in the master switch device 502c may utilize either or both of the in-band connection 310a and the out-of-band connection 310b provided by its communication system 308 in order to provide for management access and internal operations. For example, the master switch device 502c may be the only switch device in the switch device cluster that provides the switching fabric 600 that is exposed to external management entities such as the server device 204 and storage device 206. The exposure of the master switch device 502c may be enabled by the switching fabric engine 304 in the master switch device 502c exposing a REpresentational State Transfer (REST) Application Programming Interface (API) that allows external entities to access management functionality in the master switch device 502c, which allows control/management/monitoring functionality performed by the master switch device 502c at block 410 to be controlled by an management device. As such, the master switch device 502c may provide a single management “touch point” for the switching fabric 600 using a REST model that may allow in-band or out-of-band management access via, for example, a virtual IP (vIP) address assigned to the master switch device 502c (i.e., a master vIP), and/or physical IP addresses (e.g., IPv6 addresses) assigned to the master switch device 502c and slave switch devices 502a, 502b, and 502d-i. As will be appreciated by one of skill in the art in possession of the present disclosure, the structure of the REST model allows the master switch device 502c to capture the core relationships among the elements in the switching fabric 600.

In some embodiments, the switching fabric engine 304 in the master switch device 502c may maintain the liveliness of each of the slave switch devices 502a, 502b, and 502d-i in order to, for example, enable the determination of when any of the slave switch devices 502a, 502b, and 502d-i become unavailable. Similarly, the switching fabric engine 304 in each of the slave switch devices 502a, 502b, and 502d-i may maintain its own connectivity to the master switch device 502c. As such, the switching fabric engine 304 in the master switch device 502c may listen for events from each of the slave switch devices 502a, 502b, and 502d-i and respond to those events, and the switching fabric engine 304 in each of the slave switch devices 502a, 502b, and 502d-i may listen to events from the master switch device 502c and may separately respond to those events.

In some embodiments, the switch device cluster that provides the switching fabric 600 may support multiple fabrics. For example, as would be understood by one of skill in the art in possession of the present disclosure, ports on different switch devices in the switching fabric 600 may be provided as part of a Link Aggregation Group (LAG) using Virtual Link Trunking (VLT), a proprietary aggregation protocol available from DELL® Inc. of Round Rock, Tex., United States, that provides those switch devices as part of a VLT fabric (i.e., a forwarding fabric) that is supported by the switching fabric 600 (e.g., provided by a switch device cluster/management fabric).

In some embodiments, the forwarding plane provided by the switching fabric 600 does not require special vendor proprietary features from the Network Processing Unit (NPU) that is utilized to provide switching functionality in the switch devices 300. As such, the switching fabric engine 304 may be independent of the NPU (i.e., hardware independent), and may only depend on the operating system that is utilized by the switch device 300 and provided by a Central Processing Unit (CPU) in the switch device 300 that communicates with the NPU via any of a variety of interfaces that would be apparent to one of skill in the art in possession of the present disclosure. Furthermore, the functionality of the master switch device 502c and the slave switch devices 502a, 502b, and 502d-i may be enabled via a modular plug-in architecture and distributed models. In some examples, configurations via of the switch device cluster that provides the switching fabric 600 may be automated in a variety of manners including, for example, a set of policies (e.g., policies to configure server devices in a particular manner when connected to the switching fabric 600 based on, for example, a server device identifier detected in that server device upon its connection to the switching fabric 600) and/or meta data (e.g., fabric mode meta data, attached system discovery identity meta data, etc.) injection.

As such, at block 410, the switching fabric engine 304 in the master switch device 502c may perform any of a variety of control operation on one or more of the slave switch devices 502a, 502b, and 502d-i that may include, for example, configuring a Link Aggregation Group (LAG) using a plurality of ports on one or more of the slave switch devices 502a, 502b, and 502d-i; setting up the forwarding of data traffic on one or more of the slave switch devices 502a, 502b, and 502d-i; providing bindings between ports and VLANs; providing bindings between ports, LAGs, and VLANs; utilizing the Link Aggregation Control Protocol (LACP) on ports; performing physical port configurations such as Maximum Transmission Unit (MTU) configurations and auto-negotiation configurations; providing storage configurations; providing data uplink related configurations such as VLAN configurations, LACP configurations, and LAG configurations; and/or a variety of other control operations that would be apparent to one of skill in the art in possession of the present disclosure.

Thus, systems and methods have been described that provide switching fabrics using a plurality of switch devices that operate to configure themselves into a switching fabric via communications that result in those devices discovering each other and forming a switch device cluster, and then electing one of those switch devices as a master switch device for the switch device cluster/switching fabric such that the remaining switch devices are designated as slave switch devices in the switch device cluster/switching fabric. Following the configuration of the switching fabric, the master switch device may perform control operations on any of the slave switch devices. Furthermore, the master switch device may share its master switch device configuration with each of the slave switch device, which allows any of those slave switch devices to configure themselves as a master switch device in the event the switch device that is operating as the master switch device becomes unavailable. As such, switching fabrics may be configured and managed without the need for an external device with its own Central Processing Unit (CPU), and may instead be configured and managed using the CPU in the switch devices that are already being used to provide the switching fabric. Thus, the configuration of switching fabrics is provided in a manner that reduces the complexity, ongoing operational overhead, and relatively long times required for new system deployment, as well as eliminates the need for to provide a device external to the switching fabric that performs the management and control functionality for the switching fabric, thus reducing the cost of managing and controlling the switching fabric.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A switching fabric configuration and management system, comprising:
a plurality of switch devices that are coupled to each other, wherein each of the plurality of switch devices is configured to:
identify, in a switching fabric database in that switch device, a domain;
determine others of the plurality of switch devices that share the domain;
communicate with the others of the plurality of switch devices that share the domain to designate a master switch device and one or more slave switch devices from the plurality of switch devices that share the domain, wherein the designation of the master switch device and the one or more slave switch devices configures the master switch device and the one or more slave switch devices as a switching fabric, and
wherein each of the one or more slave switch devices is configured to:
report their slave switch device status to the master switch device; and
wherein the master switch device is configured to:
perform at least one control operation on the at least one slave switch device.

2. The system of claim 1, wherein the determining the others of the plurality of switch devices that share the domain includes each of the plurality of switch devices:
retrieving, from the switching fabric database in that switch device, a domain identifier that identifies the domain; and
exchanging that domain identifier with the others of the plurality of switch devices via a Virtual Local Area Network (VLAN).

3. The system of claim 1, wherein the designation of the master switch device and the one or more slave switch devices from the plurality of switch devices includes each of the plurality of switch devices:
performing Virtual Router Redundancy Protocol (VRRP) operations to elect the master switch device and designate the one or more slave switch devices.

4. The system of claim 1, wherein the master switch device is configured to:
transmit master switch device configuration information for the master switch device to each of the one or more slave switch devices.

5. The system of claim 4, wherein the master switch device is a primary master switch device, and wherein at least one of the one or more slave switch devices is configured to:
store, in the switching fabric database in that switch device, the master switch device configuration information; and
determine that the primary master switch device has become unavailable and, in response, use the master switch device configuration information to configure itself as a secondary master switch device.

6. The system of claim 1, wherein each of the plurality of switch devices includes a switching fabric engine that is configured to enable the functionality of that switch device, and wherein that switch fabric engine is hardware independent.

7. An Information Handling System (IHS), comprising:
a processing system; and
a memory system that is coupled to the processing system and that includes instructions that, when executed by the processing system, cause the processing system to provide a switching fabric engine that is configured to:
identify, in a switching fabric database, a domain;
determine at least one switch device that shares the domain;
communicate with the at least one switch device that shares the domain to designate the IHS as a master switch device and the at least one switch device that shares the domain as at least one slave switch device, wherein the designation of the master switch device and the at least one slave switch device configures the master switch device and the at least one slave switch device as a switching fabric;
receive, from each of the at least one slave switch device, a report of their slave switch device status; and
perform at least one control operation on the at least one slave switch device.

8. The IHS of claim 7, wherein the determining the at least one switch device that shares the domain includes:
retrieving, from the switching fabric database, a first domain identifier that identifies the domain;
exchanging the first domain identifier with the at least one switch device via a Virtual Local Area Network (VLAN); and
receiving, from each of the at least one switch device, a second domain identifier that is the same as the first domain identifier.

9. The IHS of claim 7, wherein the designation of the IHS as the master switch device and the at least one slave switch device from the at least one switch device includes:
performing Virtual Router Redundancy Protocol (VRRP) operations to elect the master switch device and designate the one or more slave switch devices.

10. The IHS of claim 7, wherein the master switch device is a primary master switch device, and wherein the switching fabric engine is configured to:
transmit master switch device configuration information for the primary master switch device to each of the at least one slave switch device, wherein the master switch device configuration information is configured to allow any of the at least one slave switch device to configure itself as a secondary master switch device in the event the primary master switch device becomes unavailable.

11. The IHS of claim 7, wherein the switch fabric engine that is hardware independent.

12. The IHS of claim 7, wherein the switching fabric engine is configured to:
detect an event occurring in the at least one slave switch device; and
perform, in response to detecting the event, the at least one control operation on the at least one slave switch device.

13. The IHS of claim 7, wherein the switching fabric engine is configured to:
detect that the at least one switch device has become unavailability; and
perform, in response to detecting the unavailability of the at least one switch device, the at least one control operation on the at least one slave switch device.

14. A method for configuring and managing a switching fabric, comprising:
identifying, by a first switch device in a switching fabric database, a domain;
determining, by the first switch device, at least one second switch device that shares the domain;
communicating, by the first switch device, with the at least one second switch device that shares the domain to designate the first switch device as a master switch device and the at least one second switch device that shares the domain as at least one slave switch device, wherein the designation of the master switch device and the at least one slave switch device configures the master switch device and the at least one slave switch device as a switching fabric;
receive, by the first switch device operating as the master switch device from each of the at least one slave switch device, a report of their slave switch device status; and
performing, by the first switch device operating as the master switch device, at least one control operation on the at least one slave switch device.

15. The method of claim 14, wherein the determining the at least one switch device that shares the domain includes:
retrieving, by the first switch device from the switching fabric database, a first domain identifier that identifies the domain;
exchanging, by the first switch device, the first domain identifier with the at least one second switch device via a Virtual Local Area Network (VLAN); and
receiving, by the first switch device from each of the at least one second switch device, a second domain identifier that is the same as the first domain identifier.

16. The method of claim 14, wherein the designation of the first switch device as the master switch device and the at least one slave switch device from the at least one second switch device includes:
performing, by the first switch device, Virtual Router Redundancy Protocol (VRRP) operations to elect the master switch device and designate the one or more slave switch devices.

17. The method of claim 14, wherein the master switch device is a primary master switch device, and wherein the method includes:
transmitting, by the first switch device acting as the master switch device, master switch device configuration information for the primary master switch device to each of the at least one slave switch device, wherein the master switch device configuration information is configured to allow any of the at least one slave switch device to configure itself as a secondary master switch device in the event the primary master switch device becomes unavailable.

18. The method of claim 14, wherein the first switch device includes a switch fabric engine that is configured to enable the functionality of the first switch device, and wherein that switch fabric engine is hardware independent.

19. The method of claim 14, further comprising:
detecting, by the first switch device operating as the master switch device, an event occurring in the at least one slave switch device; and
performing, by the first switch device operating as the master switch device in response to detecting the event, the at least one control operation on the at least one slave switch device.

20. The method of claim 14, further comprising:
detecting, by the first switch device operating as the master switch device, that the at least one slave switch device has become unavailability; and
performing, by the first switch device operating as the master switch device in response to detecting the unavailability of the at least one slave switch device, the at least one control operation on the at least one slave switch device.
